(19) United States
(12) Patent Application Publication
(10) Pub. No.: US 2012/0173476 A1
(43) Pub. Date: Jul. 5, 2012

(54) System and Method for Rule-Based Asymmetric Data Reporting

(76) Inventor: Nasir Rizvi, Ashburn, VA (US)

(21) Appl. No.: 13/343,539

(22) Filed: Jan. 4, 2012

Related U.S. Application Data
(60) Provisional application No. 61/429,659, filed on Jan. 4, 2011.

(51) Int. Cl. G06F 17/30

(52) U.S. Cl. 707/601; 707/600; 707/E17.005

(57) ABSTRACT

A system and method for rule-based asymmetric data reporting having analyst created rules and pre-established rule-based templates. Analysts create data measures together with connection information for the data repository from which the data measures can be obtained. Whenever reports or templates are used with predefined rules, reports are automatically updated with the data measures required. Provisions are made for sparkline integration and e-mail notification. Analysts are able to create spreadsheet reporting without the need for knowledge of formula formatting and insertion.

### FIELD OF INVENTION

This application relates generally to systems and methods for supporting analysts in the evaluation and reporting of multidimensional data.

### BACKGROUND

A great deal of data reporting occurs in the form of spreadsheets that are embedded in reports or are used as standalone tools to report to management. Different managers at different levels require different types of reports and have individual preferences as to how reports are made and what information is most useful. Accounting departments rarely have time to do analysis because they are so busy updating reports with the latest data that reaches them. In order to do the analysis that many managers require, analysis from a variety of spreadsheets may be necessary which would also include custom implementation of formulas in order to meet the needs of a particular manager. In many cases, the advanced functions available in software such as Microsoft Excel are simply beyond the reach of the common analyst.

In general, financial and business organizations require that data reporting, performance management, budgeting and forecasting, internal controls, and external reports will be generated from time to time. Each time a particular report must be generated, that report can vary from the previous report due to additional data that have been made in the intervening period. It is difficult to do in-depth reporting when attention must be paid to the various data that come in on a constant basis. Accuracy further suffers when reports are generated without the most current data.

### SUMMARY

Embodiments described herein enable analysts to access the capabilities of an online analytical processing (OLAP) cube from within a spreadsheet software application, such as Microsoft Excel to generate reports by automated rule based selection and updating of cells within a spreadsheet. Embodiments provide the analyst with tools for retrieving necessary data, without the need to manually write formulas or have knowledge of database management or programming techniques. In various embodiments a processor receives the analyst's selection of the desired data source and the desired tables with the selected data source. Multiple fields in multiple tables may be selected by the analyst as input to various analytical tasks. The processor comprises instructions for retrieving the necessary data from the selected tables, loading the data into an OLAP cube and creating measures associated with the various fields selected. The processor also comprises instructions for creating an automated analysis and methodology as a series of rules, based upon the measures and the analysis required and associated with the particular report or analytical task. Various embodiments described herein allow data to be refreshed and an analysis to take place by simply accessing a particular report comprising various measures. The measures, together with the analysis steps that operate on those measures to give rise to a particular report are then automatically executed on the retrieved measures and populated into a spreadsheet that is of particular relevance to a particular report.

Other embodiments allow for the order of data analysis to be specified for any particular task or report and for any particular manager based upon an analyst-defined rule set. Thus a capability of various embodiments herein allow a manager to determine what types of reports are desired, the desired order of presentation, and what analyses are presented based upon the desired order.

Other embodiments, for example, allow any specific periodic report to be created and automatically updated each time an analyst retrieves the report. In short, embodiments herein allow an analyst to specify a report identifier and have all subsequent steps associated with and dictated by that report identifier including specifying the measures to be retrieved, where those measures may be retrieved from, and rules for how those measures are to be processed in order to give the necessary information for the report. Thereafter, each time the report is opened, a connection is made to the appropriate data source from which the measures can be retrieved, the measures are retrieved, the measures are processed as previously defined by the analyst in the report rule set, and the results of that analysis of populated into an OLAP cube for populating a spreadsheet that can either be presented to management or used by the analyst immediately.

In an embodiment, the saved report and associated rule set can be updated each time the report is accessed. For example a monthly report would be automatically updated each time the analyst desires the report to be created. Alternatively, the engine of the various embodiments can periodically run in accordance with time based rules, and thereby update the report in a background mode by retrieving measures that are needed for the report from the data sources in which they reside on a scheduled basis. Thus whenever the analyst requests a particular report, the measures have already been analyzed and can be populated into a spreadsheet without further analyst interaction.

In an embodiment, a form of “dashboard” (GUI) is presented to an analyst with all of the tasks for that analyst listed thereon. For example, a particular report to be worked on by the analyst can be listed as a task for that analyst. For any particular person there may be a variety of different reports presented depending upon their job description and position within a company or entity.

After logging onto the system with appropriate identification, the analyst can access the list of reports that have been assigned. Each report will have its own report identifier, an associated series of measures to be retrieved for use in the report, the data source connection information necessary to retrieve the selected measures, and a predetermined series of analytical steps to be used to manipulate the measures that are retrieved. When the analyst clicks on the report to be created, a connection is made to the appropriate data source(s) from which the measures are retrieved, the measures are retrieved, populated into the OLAP cube and acted upon as specified in the predetermined analytical steps or rules for analysis. The results are then populated into a spreadsheet to be created based upon the desired report. In short, the report identifier is a tag that triggers a variety of other rule-based actions to take place to allow manipulated data be presented to the analyst in spreadsheet form or as otherwise may be specified (for example, a formatted text report).

The dashboards of the various embodiments are specific to the analyst and the level of activity to be performed by the analyst. Thus an entry-level analyst might be responsible for one level of reporting while a higher level analyst will be responsible for other types of reporting. Thus each analyst will have different tasks presented to him and different permissions for data source access available on the dashboard depending upon the analyst's position within the organization.

The engine and interface is organized around a series of specific analytical modules. These modules permit different reports to be created, depending on the permissions of each analyst. Each module implies specific permissions for accessing various portions of corporate data sources. For example, not all analysts will be permitted to review the compensation records for the highest officials of the Corporation. Conversely, the CFO of the Corporation may have permissions to review all modules and accessible portions of the data source.

Working papers available for each area of analysis and each module assist the analyst and inform that analyst concerning the type of task to be accomplished and the type of report to be created. Working papers are segregated by modules so that only those papers that are relevant to a particular module are available to the analyst. Tabs are presented that are relevant to the level of the task assigned to a specific analyst. Working papers may be, but are not limited to, various written products that would inform an analyst about issues that are important to the analytical task to be performed. Thus while rules are created for the retrieval and processing of various measures, other written products from different databases that are not susceptible to mathematical manipulation, but which are relevant to the analytical task to be performed, can be retrieved from various sources and placed into a library of working papers that are particularly useful to an analyst performing a particular task. Such working papers may be internally generated in a company or entity or they may be other reports generated by on related entities but which are important to the analytical task being performed.

Tasks are assigned to an analyst together with the actual supporting documents necessary to perform the task. When a specific task is assigned, the associated analyst may be alerted via e-mail or other electronic communications means that a task has been assigned. When that analyst accesses his particular dashboard, all of the associated reports, working papers, and methodology for performing the task appear on that analyst's dashboard. Thus all information necessary for an analyst to perform a task is bound together and associated with the task to be accomplished via the electronic summary document(s).

In an embodiment, report templates for generating reports is stored in a central server. They are utilized by analysts to perform the specific tasks assigned to them. For example, when a task comprising the generation of a sales summary report is assigned, a series of templates, which are available via a pulldown menu, are also made available to the analyst. These templates relate only to accomplishment of the assigned task. Thus the system utilizes rules for the presentation of relevant templates to an analyst based upon the task to be performed. Thus the analyst does not have to search through a list of templates to determine which templates are relevant to the analytical task. As the analyst generates reports necessary to respond to a specific task, the embodiments illustrated herein place the resulting spreadsheet directly into the sales summary report. The system processor, using the rules associated with data retrieval for each report, populates the spreadsheet with the appropriate numbers resulting from the analytical steps that have been predetermined based upon the rules of the specific report template. Thus the analyst deals with processed numbers rather than being burdened with retrieving and working on those numbers each time the sales summary report, or other report type, is to be completed.

The work savings resulting from the various embodiments illustrated herein result from the fact that when an analyst clicks on a particular cell, the analyst is automatically connecting to numbers that are stored in an OLAP cube or other data source. Thus the cell always displays the latest data that are in the data source since the cell has underlying connection (or link) information as to where the latest data can be obtained and instructions for retrieving such data. Thus there is no need for the analyst to connect to the data source, locate the correct data storage, and retrieve that data since the system will automatically update such information when a cell is clicked, or alternatively, when a specific report is requested.

In another embodiment, when a particular analyst signs on to the system, the system processor knows what reports are potentially to be generated by that analyst and automatically updates and populates those reports with the necessary measures as soon as the analyst signs on to the system.

Because all data that is desired comprises links to one or more data sources, an analyst does not have to repeat steps when the analyst signs on the system. If data necessary for a particular report needs to be accessed, it is automatically accessed when the analyst signs on by virtue of identification of any particular report identifier which in turn specifies the measure(s) with a connection link as to where the underlying data can be found that will satisfy the rules associated with the data needed for a given report. Thus when the screen is displayed for a particular analyst, it always has the most updated information automatically populated to appropriate cells.

The system further comprises an indexing and status monitoring capability concerning the progress and completion of any task. If a task is partially completed, the system logs this information so that the next time the particular analyst logs onto the system, the analyst picks up where the analyst left off.

Thus the system processor comprises instructions that cause the processor to retrieve tasks for a particular report, to present those tasks to the analyst via the analyst dashboard, to connect to the data source(s) needed to perform the analyst's tasks and relates that information to the normal workflow. An analyst obtains only data that is needed. The analyst does not have to repeat or enter any formulas in order to obtain the necessary information; rather the system automatically updates all necessary information as dictated by the rules associated with any given report.

The report engine provides the means to populate data into a spreadsheet. For example, an analyst may want particular data from a particular source. In that case, the analyst can specify the server and what type of information that is desired. The analyst can flexibly specify the data source from which information is to be obtained. Thereafter, the system connects to the appropriate data source, and data source can be queried for the information needed.

### BRIEF DESCRIPTION OF THE DRAWINGS

FIGS. 1 and 2 illustrate embodiments of the system having a report engine operating on a computing device, an integrated notification engine, and a plurality of data sources.

FIG. 3 is a process block diagram illustrating functional modules involved in creating a report, namely, receiving a natural language request from an analyst, retrieving and processing the necessary data, and producing a report as specified by the analyst.

FIG. 4 is a process block diagram illustrating functional modules involved in accessing and updating an existing report.

### DETAILED DESCRIPTION

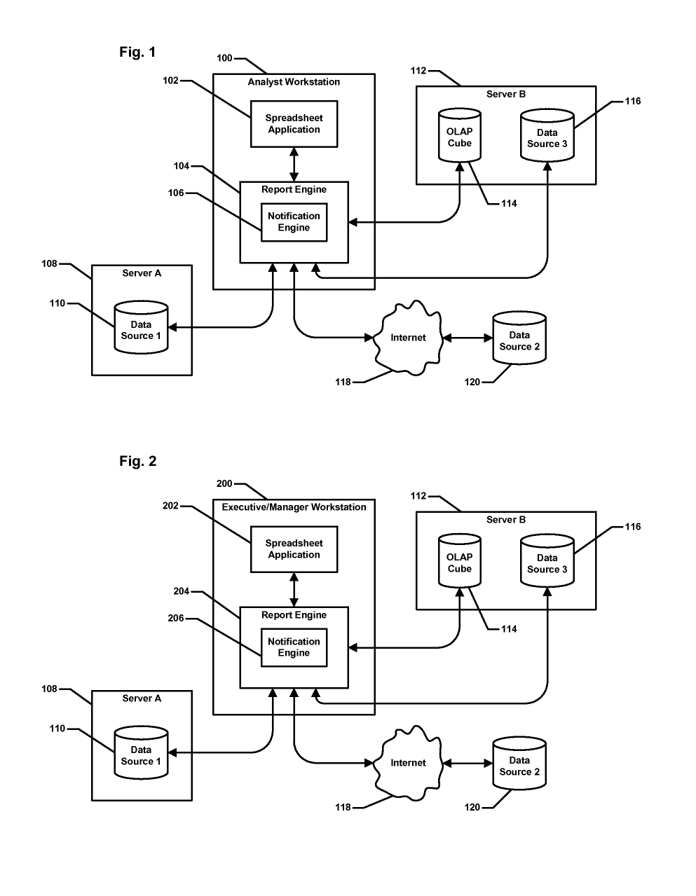

Referring to FIG. 1, an analyst workstation 100 is shown. The analyst workstation 100 comprises software instructions for operating a spreadsheet application and a related report engine. An analyst accesses the report engine 104 via a computing device 100. Such devices may be, without limitation, desktop computers, laptop computers, smartphones, tablet computers and the like. The report engine 104 is configured with computer instructions causing the report engine to execute functions that allow the report engine to create functional links to the enterprise spreadsheet application 102 and manage data links to a plurality of data sources 110, 116 and 120. While three data sources are illustrated, this is not meant as a limitation. Any number of data sources may be accessed by the report engine 104. The data sources may be located on servers which are internal to the organization or business enterprise 108 and 112, or may be external data sources. Alternatively, data sources may be accessed over the internet 118 or similar computer network.

The report engine 104 contains instructions to retrieve data from the data sources 110, 116 and 120 according to analyst specifications, and store the data in an OLAP cube 114 located on a server 112. The report engine 104 has further instructions that process the data stored in the OLAP cube 114 as specified by the analyst when the report engine retrieves that data in response to an analyst request for a specific report to be generated. The report engine 104 has instructions that control the notification engine 106, which provides notification to analysts as required. The notification engine 106 has instructions that format notifications according to analyst preferences and send messages in a variety of formats, such as email or SMS text.

The notification engine may be optionally programmed by the analyst to automatically send notification messages. Such notifications may be time based, for example, sending a notification message to managers every morning at 9:00 AM with the latest sales report, or may be based on specified data, for example, sending a report whenever monthly gross sales reaches a predetermined value.

Referring to FIG. 2, an executive/manager workstation 200 is shown. The executive/manager workstation 200 comprises software instructions for operating a spreadsheet application and a related report engine. An executive/manager accesses the report engine 104 via a computing device 200. Such devices may be, without limitation, desktop computers, laptop computers, smartphones, tablet computers and the like. The report engine 104 is configured with computer instructions causing the report engine to execute functions that allow the report engine to create functional links to the enterprise spreadsheet application 102 and manage data links to a plurality of data sources 110, 116 and 120. While three data sources are illustrated, this is not meant as a limitation. Any number of data sources may be accessed by the report engine 104. The data sources may be located on servers which are internal to the organization or business enterprise 108 and 112, or may be external data sources. Alternatively, data sources may be accessed over the internet 118 or similar computer network.

The report engine 104 contains instructions to retrieve data from the data sources 110, 116 and 120 according to analyst specifications, and store the data in an OLAP cube 114 located on a server 112. The report engine 104 has further instructions that process the data stored in the OLAP cube 114 as specified by the analyst. The report engine 104 has instructions that control the notification engine 106, which provides notification to analysts as required. The notification engine 106 has instructions that format notifications according to analyst preferences and send messages in a variety of formats, such as email or SMS text.

The notification engine may be optionally programmed by the analyst to automatically send notification messages. Such notifications may be time based, for example, sending a notification message to managers every morning at 9:00 AM with the latest sales report, or may be based on specified data, for example, sending a report whenever monthly gross sales reaches a predetermined value.

Referring to FIG. 3, a process block diagram of the functional modules of the report engine for the creation of a report is illustrated. The report engine 104 receives a report request from an analyst using natural language 302. The analyst does not need to know any spreadsheet formulas or have any computer programming background. The report engine 104 contains rules for converting the natural language request into appropriate computer code, such as SQL queries 304. The report engine 104 contains instructions for creating rules for determining the appropriate sources for the requested data and conditions for retrieving such data 306. The report engine 104 retrieves the necessary data 308 from a plurality of data sources 110, 120, 116 according to the rules and stores the data in an OLAP cube 310. The report engine 104 contains instructions to interpret the natural language instructions entered by the analyst into appropriate formulas and equations to produce the type of report requested by the analyst 312. Once all necessary processing is complete, the report engine 104 generates a report in spreadsheet form 314 which is accessible by the analyst. The report engine 104 stores connection data for accessing the various data sources, the queries to be performed on each data source to retrieve the necessary data, and the rules for retrieving such data within the generated spreadsheet 314.

The analyst may save the generated report 314 on a server or other data storage device such as a hard drive on the analyst's workstation. Alternatively, the analyst may send the generated report vie email or other electronic communications means.

The analyst may also optionally specify conditions when the report engine will automatically update the data in specified reports. Such parameters include time based intervals and data driven intervals. For example, the report engine may automatically update a report every hour, or according to frequency rules that dictate the frequency at which different measures should be retrieved, or may update a report in response to data meeting specified criteria.

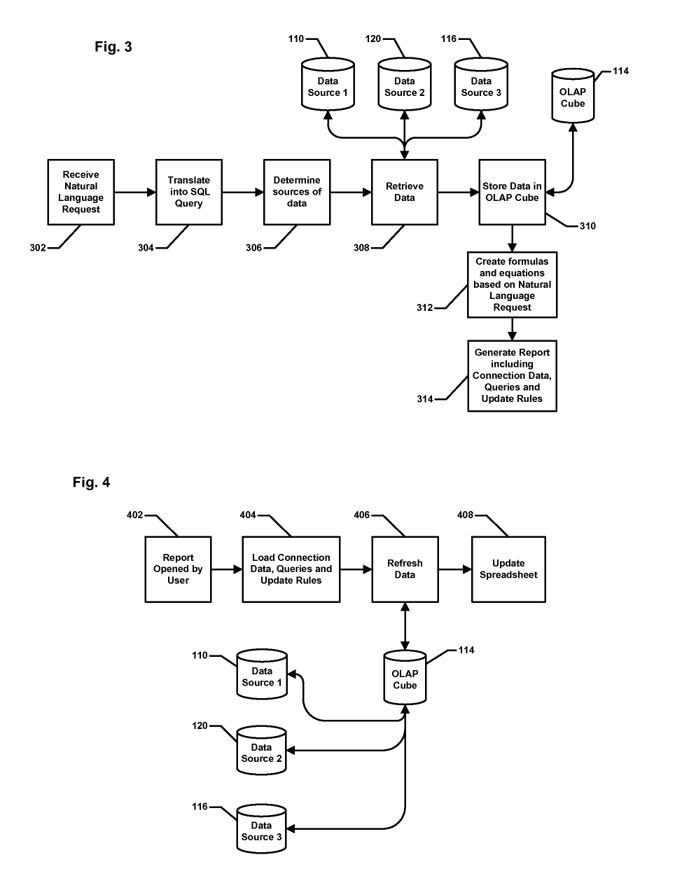

Referring to FIG. 4, a process block diagram of the functional modules of the report engine 104 for accessing and updating a previously generated report is illustrated. Whenever the previously generated report is accessed by the analyst or any other recipient 402, the report engine 104 automatically loads the data retrieval rules 404 comprising connection information, defined formulas and equations stored in the previously generated report 314. The report engine 104 executes the data retrieval rules to access the OLAP cube 114 and retrieve updated data 406. The report engine 104 populates the previously generated report 314 with the updated data 408.

In an embodiment, the data in the OLAP cube 114 may be updated from a plurality of data sources 110, 120, 116 according to the rules saved in the previously generated report. Alternatively, the OLAP cube may contain instructions to automatically update the data contained in the cube from a plurality of data sources 110, 120, 116, such that the OLAP cube always contains the most up-to-date data.

In various embodiments, all queries used to generate a particular type of report are made in a natural language rather than in the form of equations. As such, analysts no longer have to learn the equation language of the spreadsheet or programming language/code in order to pull information into desired criteria into the report. The type of report is then stored with a report identifier to make it easy for the analyst to recreate a particular report type with updated data.

A series of visual buttons on the analyst dashboard specify different functions of the report engine. For example an analyst can paste information horizontally, vertically, or in any cube based upon analyst desires. By clicking on the horizontal paste button for example, one can paste desired information horizontally into a spreadsheet. The analyst no longer has to individually paste data into cells of the spreadsheet.

In another embodiment, an analyst may not know the names or headings of information to be pasted but may know the criteria associated with that information. For example, it may be desired to work on specific job numbers; however the analyst may not know the job numbers to paste into the spreadsheet. In this situation an analyst can specify jobs having particular criteria such as numbers of hours above a certain level or costs of a particular amount. By simply entering the criteria desired, the engine will find the jobs meeting those criteria and automatically paste them in the desired orientation into a spreadsheet.

In various embodiments, an analyst can paste a group of data into a spreadsheet as a named group. For example, once all of the job numbers in the above example are pasted into a spreadsheet the analyst has the option to name this group of job numbers and see the group under this assigned name. Once the group name is saved, the analyst will always be able to call all the members of the group as a set. Further, once specific analysis steps are taken associated with the group, all of the underlying data associated with each member of the group is automatically called and updated when the analyst desires to access that group. Further, an analyst can obtain the underlying data associated with any member of the group by simply clicking on the cell associated with that particular member.

As part of any analysis task, an analyst specifies measures associated with that task. This can be accomplished by clicking on the desired measures from a pulldown menu. For example, an analyst would initially select “hours” as a desired measure for a particular job from the pulldown menu. Thereafter, when an analyst accesses that particular job, members of a particular group will be shown and the hours associated with each member of the group will be automatically pulled from the appropriate data source by virtue of the connection information that had been previously provided. When the analyst clicks on the job number that is displayed, the number of hours is automatically shown to the analyst. If the analyst has specified an operation to be performed on the hours retrieved, for example average hours spent per employee, that analysis task would automatically be applied to the number of hours retrieved so that the analyst would see processed information resulting from the retrieved data. If that task is to be repeated for each member group, the analyst would see processed information for each member of that group when the analyst clicks on the individual cell associated with the individual member of the group.

As a further example, if all labor costs for jobs are located within cells, then the analyst would simply specify how the labor costs are to be determined (for example number of hours spent times the rate per hour of the individuals spending the time on a given job, with that amount summed over all individuals working on the job). Thereafter, the analyst would simply designate a particular cell, and the number of hours spent by each employee would be pulled from the appropriate data source, each hourly rate will be pulled from the appropriate data source, the rate times the number of hours spent calculated, and the end result would be displayed for the analyst on a cell by cell basis. The analyst would simply inquire about the measure in a particular cell by clicking on that cell.

As a further enhancement, the report engine of the various embodiments contains instructions which allow an analyst to insert a “slicer” into the equation so that information presented can be sliced in a particular manner that is germane to the desires of the analyst. Using the above example of labor cost, by inserting a slicer into the measure and specifying, for example a year by year slicing of data, the analyst can directly display the slicing of the labor cost information on a year by year basis. The analyst would then have the hours for each job on a year-by-year basis to present to a manager if desired.

In the various embodiments, all cells are connected to the data from the appropriate data source at all times so that in the event the underlying data is updated, the analyst will get current information as it is updated. The analyst can also specify how often updating occurs, by the specification of frequency rules, for example as data is changed, hourly, daily, or any other period meaningful to the analyst.

The system also comprises methodology for utilizing pivot tables. In data processing, a pivot table is a data summarization tool found in data visualization programs such as spreadsheets. Among other functions, pivot-table tools can automatically sort, count, and total the data stored in one table or spreadsheet and create a second table (called a “pivot table”) displaying the summarized data. The analyst sets up and changes the summary's structure by dragging and dropping fields graphically. This “rotation” or pivoting of the summary table gives the concept its name. Once again however, there are limitations for an analyst based upon knowledge of how to establish a pivot table and how to interpret the data in the pivot table.

Using pivot tables, one can only select the row and column for reviewing data. For example, using a pivot table one can see labor costs over a period of months. The analyst cannot specifically show specific points for specific jobs. In order to see specific points, the analyst must list everything in the pivot table in some fashion in order to obtain the desired information. There is no succinct way of reporting on the contents of individual cells.

In the various embodiments described herein, an analyst can take multidimensional information and put it into a single cell. Thus a pivot table can be created in an individual cell, or over a series of cells to display both summarized information and underlying information whenever desired by the analyst. For example, the analyst may wish to see specific jobs for specific months with summary information to be displayed in a single cell. Using the various embodiments described herein, the analyst can specify these different jobs regardless of how they are initially recorded in a data source. The jobs do not have to be in sequential order, be part of any prior grouping of jobs, or be part of any other structure. Any grouping the analyst desires can be accomplished and displayed in a single cell. This is sometimes referred to as “asymmetrical reporting.” The analyst would specify the measure desired (for example certain jobs and the number of hours associated with those jobs for certain time periods). That information can be shown in a particular cell. The analyst can click on the cell and the underlying information will be displayed. In addition, the analyst can add other measures to be retrieved and added to the cell and that information would be shown as well.

Thus the analyst can create a specific template of information that can be inserted into a report rather than simply reporting a grid of information for all jobs for all months for all hours that then has to be summarized by managers. To create a balance sheet, the analyst can do the normal grid type data retrieval but can also have subtotals and other information behind each cell that can be quickly reported to a manager. For example, the analyst can show cash accounts for specific jobs by simply clicking on a cell as opposed to providing a separate listing of all jobs from which all information would have to be retrieved.

As another example, one may want an amount measure for specific jobs hidden within a cell. In this case the analyst would attach a slicer to the cell and then report on information in that cell sliced in any particular fashion desired. Further, information would be consistently updated with the latest data as noted above. For example, if a current report is being provided, and the analyst specified the accounts desired, revenues coming from specific accounts would be updated each time the analyst displayed the desired report. The information necessary for the report, the pivot table and the analysis in structure will be performed prior to that information being displayed or being made available to the analyst.

The various embodiments noted herein provide an upgrade to spreadsheet software applications such as Microsoft Excel although this is not meant as a limitation. Other spreadsheet software will equally benefit from the embodiments disclosed herein. Using the various embodiments, an analyst does not have to learn complex formulas or programming language/code. Rather, the analyst simply needs to click on an icon, make a natural language request for information, and the appropriate equations are created. Once a particular analysis task has been accomplished, the analyst can flexibly add other conditions to that analysis task for immediate evaluation, or to be repetitively performed each time a particular report is desired.

For example, an analyst can request the number of jobs which exist with average number of hours greater than or equal to 1000 in 2009. Using natural language terms, this request is automatically put into equations to pull the data from the appropriate data source.

Another example may be to display the number of products from a particular manufacturer having a particular margin. Again the analyst would simply request this information in a natural language form, specify the connection needed to obtain the desired information and the appropriate equations would be written automatically.

Other embodiments allow an analyst to create a grouping that can be subsequently saved and from which data can be retrieved. For example, an analyst may create a report member that does not necessarily span a calendar year. A report member may be “the school year.” Then each time the analyst desires to report on a particular measure, the analyst would highlight “the school year” as a member of that report and thereafter, the desired information would be pulled from a range of dates that are associated with the school year.

Using the various embodiments, analysts can create a new measure. For example, if an analyst repetitively requires the job hours from one task in manufacturing to be added to the sales costs associated with the product of that manufacturing, and analyst can specify a measure that is the sum of those two costs. Thereafter, the analyst can send the request relating to that single measure and know the information presented is based upon the two different hourly costs desired. That measure can be named and added to a pulldown menu so that it can be retrieved whenever desired and added to any report. As another example, an analyst may define “margin” as revenue minus costs. “Margin” is then added to the list of measures available to the analyst. From that point on, each time the analyst selects the term “margin” for inclusion in a report, the appropriate data would be called from the data warehouse and provided in the cubic desired.

The engine of the various embodiments allows analysts to select members of the report by natural language. The analyst can therefore look into an OLAP cube, and query the cube without knowing any programming language at all. Thus the full utility of the various embodiments can be accomplished without having to spend large amounts time in training. Further, the various embodiments avoid normal typographical errors that might occur in the entry of equations and formulas.

Sparkline Integration: A sparkline is a type of information graphic characterized by its small size and high data density. Sparklines present trends and variations associated with some measurement, such as average cost or sales activity over time in a simple and condensed way. The term “sparkline” generally refers to a small, high resolution graphic embedded in a context of words, numbers or images. They are data-intense, design-simple, word-sized graphics. Whereas the typical chart is designed to show as much data as possible, and is set off from the flow of text, sparklines are intended to be succinct, memorable, and located where they are discussed.

Using the various embodiments, analysts can integrate sparklines into individual cells. Since individual numbers underlie each cell, the analyst simply designates the underlying information as that which is desired to be represented in a sparkline. Thereafter, whenever desired, the analyst simply clicks on the cell and the sparkline is displayed. Sparkline integration is also represented as a single button on the analyst interface.

Comparative Displays of Data: It is often the case that a manager will want to see comparative data for a particular period. If this is the case, the analyst can specify a particular series of analytical steps for a period of time and that data will be displayed for the analyst. However, if the analyst is aware that the manager would consistently wish to see the prior year's analysis of those same measures, the analyst can specify a prior-year display to be created and displayed each time the current year analysis is presented. Using the slicer function and the natural language interface, this can be specified. Thereafter, the slicer can control what columns are displayed for a manager each time that current data is reported. Therefore, the data from the desired period will always be displayed in comparison to the same data from a different period.

Sequential Data Analysis: It is often the case that management will desire reports of a particular type but then require a “drill down” through the information that is displayed. For example a reporting of the total number of man hours per quarter may be desired. Using the various embodiments, this can be easily displayed for a manager. However, if it is also known that the manager desires to know how many hours were spent on what job during that reporting period, the analyst can create that report as well and link that report to the overall hourly report such that with the click of a button, the analyst or manager can drill down through the information to the desired level.

Such drill down reports, as noted above, can be defined as a specific analysis task (“quarterly drill down reporting”) with that report name, the associated measures, the connections necessary, and the mathematical operations associated with that report, all of which can all be stored as a single report template. Graphs and sparklines can also be associated with this particular report such that whenever the analyst clicks on that desired report, all relevant reporting can be created. The analyst can define each individual layer and can define the desired order in which that data is created. The system can then define the data and the particular kind of chart desired for each level. At all times there is a display of where in the various levels of reporting the analyst or manager is located. In this fashion navigating up or down the reporting levels can be easily accomplished.

Each drill down report will have its own name. Once the analyst spends the time necessary in the beginning to establish an agreed-upon methodology, this will not have to be done again. Further, updates will not have to be specifically requested because all underlying data will be automatically updated each time the report is called.

Notification alerts: Another feature of the various embodiments is the creation of notification alerts when a particular situation exists. For example a particular division may have a travel budget assigned at the beginning of the year. The travel budget may be continually updated as journal entries are made. However, the division analyst may want a warning to be sent when a travel budget reaches 80% of that which is budgeted. Alternatively, managers may wish to receive a daily summary of sales figures with the most recent data. The analyst can create an alert which automatically updates the report and sends it to managers every morning. Using the various embodiments, such an alert can be specified and sent to the analyst via e-mail, cell phone, SMS text message, or any other communication means in a wired or wireless fashion. Similarly, even more complex analysis steps may cause notification alerts to be sent. Again, the natural language interface allows complex relationships to be specified and reported on or alerted on. Further, the analyst does not have to be online in order for these alerts to be sent. The engine of the various embodiments will continuously track certain conditions, if instructed to do so, and e-mail alerts can be sent whether or not the analyst is logged onto the system.

Alert templates are provided in a pulldown menu as well. While the various embodiments may have certain standard alert templates, an analyst can use the natural language interface to define any custom alert desired. Alerts can also be generated by trending of data, regression analysis, moving averages, and other similar calculation. As noted above depending upon the methods desired, the alerts will be formatted in accordance with various display devices. Further, the formatting will automatically be accompanied with an appropriate topic for the alert to provide immediate information to the analyst. Further, alerts do not have to be of an emergency nature but rather can be an alert that a specific periodic report is available for review. The analyst can also specify a period of time when alerts should be available, when they should start, and when they should stop.

### SUMMARY

In summary, the various embodiments eliminate the need to separately input the formulas for data manipulation that an analyst may need. This will in turn lead to more complete analysis with fewer barriers to entry in using the advanced features of any spreadsheet. An analyst can create reports without having to interface with formula functions. The analyst will therefore be able to concentrate more on what management really needs to know. The system and method illustrated herein requires no programming language or code, and querying/connecting data to individual cells/groups of cells merely requires clicks of a mouse rather than writing complicated codes and formulas.

If data resides in different data sources, the analyst simply creates the data calls so that the appropriate data sources are accessed whenever information that is needed for a particular report is required. The analyst can establish multiple connections to multiple data sources for a single report in order to retrieve the data from different data sources. Further, the system of the various embodiments presents an index of the data sources from which various measures may be obtained. The system automatically connects to multiple different data sources to obtain multiple different measures in order to generate the report needed. Further, the various embodiments can be directed to establish different refresh rates for different reports so that each report automatically refreshes with the data necessary for the report.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module executed which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A system for rule-based task analysis comprising:
a computer processor comprising instructions for operating a rules engine comprising instructions for retrieving input on a plurality of measures necessary for an analysis task;
instructions for associating each of the plurality of measures with one or more data source links from which the measures may be retrieved;
instructions for performing processing steps on the measures that are retrieved automatically upon retrieval; and
the processor comprising instructions that cause the processor to generate a response to the analysis task based upon the rule-based processed measures.

2. The system of claim 1 wherein the rules engine further comprises instructions that cause the processor to update the measure to be retrieved using a frequency rule.

3. The system of claim 1 wherein the rules engine further comprises instructions for storing data retrieved from the plurality of data sources in an OLAP cube.

4. The system of claim 3 wherein the rules engine further comprises instructions for updating the data contained in the OLAP cube by requerying the plurality of data sources each time a task is to be performed.

5. The system of claim 1 wherein the rules engine further comprises instructions for naming the report and associating the measures, the data source links and the processing steps with the report name and instructions for connecting to the data sources, retrieving updated measures, and performing the processing steps upon analyst selection of the report by name.

6. The system of claim 1 wherein the rules engine further comprises a natural language interface whereby natural language is received and automatically converted to the processing steps comprising mathematical formulas.

7. The system of claim 6 wherein natural language actions are presented to the analyst via a pulldown menu or similar visual device.

8. The system of claim 1 wherein the rules engine further comprises instructions for generating an alert associated with an analyst-defined condition, the alert to be generated when the analyst-defined condition is satisfied.

9. The system of claim 8 wherein the rules engine further comprises instructions for send the alert to devices selected from the group consisting of cell phones, PDAs, desktop computers, tablet computers, and pagers.

10. The system of claim 1 wherein the report comprises separate layers, each associated with one another.

11. The system of claim 10 wherein the rules engine further comprises instructions for establishing an order of presentation to the separate layers of the report.

12. The system of claim 1 wherein the rules engine further comprises instructions for interfacing with spreadsheet software programs.

13. The system of claim 1 wherein the rules engine further comprises instructions for permitting an analyst to manipulate data within a spreadsheet software application.

14. The system of claim 1 wherein the rules engine further comprises instructions for analyst-defined integration of sparklines associated with individual cells of a spreadsheet.

15. The system of claim 1 wherein the data sources from which measures are retrieved are accessed via the internet or other similar global computer network.

16. The system of claim 1 wherein the data sources from which measures are retrieved are located within the enterprise computer network.

17. A method for rule-based reporting comprising:
receiving a natural language request from an analyst;
processing the natural language request to determine data to be retrieved and locations from which to retrieve specified data measures;
creating formulas and equations based on the natural language request;
generating a spreadsheet report wherein the data is automatically updated and processed according to established rules.

18. The method of claim 17 wherein the frequency at which data is updated is established based on analyst preferences.

19. The method of claim 17 wherein data retrieved from a plurality of data sources may be stored and processed in an OLAP cube.

20. The method of claim 19 wherein the OLAP cube may be periodically updated by requerying the plurality of data sources.

21. The method of claim 17 wherein the generated report may be named and saved whereby every time the saved report is later accessed, the data contained in the saved report is automatically updated and the formulas and equations recalculated.

22. The method of claim 17 wherein the natural language actions are presented to the analyst via a pulldown menu or similar visual device.

23. The method of claim 17 wherein alerts are automatically generated when analyst-defined conditions exist.

24. The method of claim 23 wherein the alert may be sent to electronic communications devices selected from the list consisting of cell phones, PDAs, desktop computers, tablet computers, and pagers.

25. The method of claim 17 wherein data associated with individual cells of a spreadsheet may be displayed as sparklines within said cells.

26. The method of claim 17 wherein analysts may directly manipulate data within a generated report.

27. The method of claim 17 wherein the data sources from which measures are retrieved are accessed via the internet or other similar global computer network.

28. The method of claim 17 wherein the data sources from which measures are retrieved are within the enterprise computer network.
